(19) United States
(12) Patent Application Publication
(10) Pub. No.: US 2017/0150165 A1
(43) Pub. Date: May 25, 2017

(54) DECODING APPARATUS AND DECODING METHOD THEREOF

(71) Applicant: SAMSUNG ELECTRONICS CO., LTD., Suwon-si (KR)

(72) Inventors: Sang-kwon NA, Seoul (KR); Myung-ho KIM, Seoul (KR); Chan-sik PARK, Hwaseong-si (KR); Ki-won YOO, Seoul (KR); Chang-su HAN, Suwon-si (KR)

(73) Assignee: SAMSUNG ELECTRONICS CO., LTD., Suwon-si (KR)

(21) Appl. No.: 15/139,842

(22) Filed: Apr. 27, 2016

(30) Foreign Application Priority Data
Nov. 23, 2015 (KR) 10-2015-0164016

(51) Int. Cl. H04N 19/51; H04N 19/30; H04N 19/187; H04N 19/176

(52) U.S. Cl. CPC H04N 19/51; H04N 19/176; H04N 19/30; H04N 19/187

(57) ABSTRACT

A decoding apparatus and a decoding method thereof are provided. The decoding apparatus includes a memory configured to store a reference image frame of a first definition that is decoded from a bit stream. The decoding apparatus further includes a decoder configured to determine, form the bit stream, a motion vector of a current block of a current image frame of a second definition, correct a size of the motion vector and a location of the current block based on a scaling factor, load, from the memory, a reference block that is the corrected motion vector away from the corrected location of the current block in the reference image frame, and decode the current image frame based on the reference block.

### CROSS-REFERENCE TO RELATED APPLICATION

This application claims priority from Korean Patent Application No. 10-2015-0164016, filed on Nov. 23, 2015, in the Korean Intellectual Property Office, the disclosure of which is incorporated herein by reference in its entirety.

### BACKGROUND

1. Field

Apparatuses and methods consistent with exemplary embodiments relate to a decoding apparatus and a decoding method thereof, and more particularly, to a decoding apparatus capable of performing motion compensation using a reference between screens, and a decoding method thereof.

2. Description of the Related Art

With the development of electronic technologies, technologies for realizing high definition and high quality images in electronic apparatuses are being actively developed. Along with this trend, the amount of information for realizing high definition and high quality images is significantly increasing as well.

Recently, not only broadcasting services of Full High Definition (FHD) but also broadcasting services of Ultra High Definition (UHD) having four times or more definition than high-definition television (HDTV) are being provided.

As display apparatuses of various performances are being developed, the quality of contents varies depending on the display apparatus. Accordingly, a video compression method is being used when a display apparatus selects high definition or low definition image information for decoding and suitably adjusts the amount of the image information for transmission.

However, the process of decoding a high definition image using low definition image information consumes a lot of memory and bandwidth, and thus when decoding is to be made in real time, sometimes a desirable screen quality is not obtained.

Therefore, to obtain a high definition and high quality image, a method for reducing consumption of memory and bandwidth in the process of decoding images may be used.

### SUMMARY

Exemplary embodiments may address at least the above problems and/or disadvantages and other disadvantages not described above. Also, the exemplary embodiments are not required to overcome the disadvantages described above, and may not overcome any of the problems described above.

One or more exemplary embodiments provide a decoding apparatus capable of minimizing consumption of memory and bandwidth, and a decoding method thereof.

According to an aspect of an exemplary embodiment, there is provided a decoding apparatus including a memory configured to store a reference image frame of a first definition that is decoded from a bit stream. The decoding apparatus further includes a decoder configured to determine, from the bit stream, a motion vector of a current block of a current image frame of a second definition, correct a size of the motion vector and a location of the current block based on a scaling factor, load, from the memory, a reference block that is the corrected motion vector away from the corrected location of the current block in the reference image frame, and decode the current image frame based on the reference block.

The second definition may be greater than the first definition, and the scaling factor may be a ratio of the first definition and the second definition.

The decoder may be further configured to determine coordinates of pixels of the current block as the location of the current block, and correct the coordinates based on the scaling factor to correct the location of the current block.

The decoder may be further configured to scale the reference block based on the scaling factor, and decode the current image frame based on the scaled reference block.

The decoding apparatus may further include a cache configured to store the reference block, and the decoder may be further configured to store the reference block in the cache, and load the reference block from the cache.

The bit stream may be coded in a base layer and an enhancement layer of a scalable video coding method.

The memory may be further configured to store the bit stream, and the decoder may be further configured to load the bit stream from the memory.

The decoder may be further configured to determine whether the bit stream is scalable video, and in response to the decoder determining that the bit stream is scalable video, decode the reference image frame from the bit stream, and store the reference image frame in the memory.

The bit stream may be scalable video when the second definition is greater than the first definition.

The decoder may be further configured to upscale the reference block based on the scaling factor, and compose residual data of the upscaled reference block to decode the current image frame.

According to an aspect of another exemplary embodiment, there is provided a decoding method including storing a reference image frame of a first definition that is decoded from a bit stream, determining, from the bit stream, a motion vector of a current block of a current image frame of a second definition, and correcting a size of the motion vector and a location of the current block based on a scaling factor. The method further includes loading a reference block that is the corrected motion vector away from the corrected location of the current block in the reference image frame, and decoding the current image frame based on the reference block.

The second definition may be greater than the first definition, and the scaling factor may be a ratio of the first definition and the second definition.

The method may further include determining coordinates of pixels of the current block as the location of the current block, and the correcting the location of the current block may include correcting the coordinates based on the scaling factor.

The method may further include scaling the reference block based on the scaling factor, and the decoding may include decoding the current image frame based on the scaled reference block.

The method may further include storing the reference block in a cache, and loading the reference block from the cache.

The bit stream may be coded in a base layer and an enhancement layer of a scalable video coding method.

The method may further include storing the bit stream, and loading the bit stream.

The method may further include determining whether the bit stream is scalable video, and in response to the determining that the bit stream is scalable video, decoding the reference image frame from the bit stream, and storing the reference image frame.

The bit stream may be scalable video when the second definition is greater than the first definition.

The method may further include upscaling the reference block based on the scaling factor, and the decoding may include composing residual data of the upscaled reference block.

### BRIEF DESCRIPTION OF THE DRAWINGS

The above and/or other aspects will be more apparent by describing exemplary embodiments with reference to the accompanying drawings, in which:

FIG. 1 is a diagram illustrating an overall configuration of a video provision system according to an exemplary embodiment;

FIG. 2 is a block diagram for explaining a configuration of a decoding apparatus according to an exemplary embodiment;

FIGS. 3A and 3B are views illustrating a process of correcting a size of a motion vector and a location of a block, according to an exemplary embodiment;

FIG. 4 is a flowchart illustrating a decoding process of a decoding apparatus according to an exemplary embodiment;

FIG. 5 is a flowchart illustrating a decoding process of a decoding apparatus according to another exemplary embodiment;

FIG. 6 is a view illustrating a display according to an exemplary embodiment;

FIG. 7 is a block diagram illustrating a detailed configuration of a TV according to an exemplary embodiment; and

FIG. 8 is a flowchart illustrating a decoding method of a decoding apparatus according to another exemplary embodiment.

### DETAILED DESCRIPTION OF THE EXEMPLARY EMBODIMENTS

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions may not be described in detail because they would obscure the description with unnecessary detail.

It will be understood that the terms “comprises” and/or “comprising” used herein specify the presence of stated features or components, but do not preclude the presence or addition of one or more other features or components. In addition, the terms such as “unit,” “-er (-or),” and “module” described in the specification refer to an element for performing at least one function or operation, and may be implemented in hardware, software, or the combination of hardware and software.

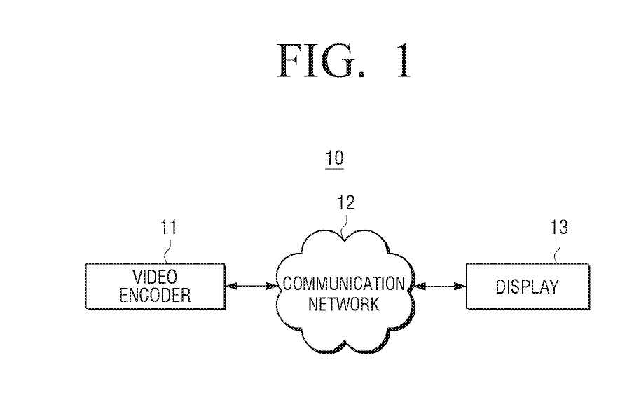

FIG. 1 is a diagram illustrating an overall configuration of a video provision system 10 according to an exemplary embodiment.

Referring to FIG. 1, the video provision system 10 according to an exemplary embodiment includes a video encoder 11, communication network 12, and display 13.

The video encoder 11 generates two or more multitrack videos from an original video, encodes and aligns the two or more multitrack videos in numerous layers using a scalable video coding method (hereinafter referred to as SVC) according to definition, frame rate, and bit, and analyzes a bit stream of a lowermost layer video to uppermost layer video of the aligned multitrack videos to extract encoding information. The video encoder 11 then performs SVC re-encoding based on the extracted encoding information. Herein, SVC will be explained in greater detail hereinafter.

Thereafter, the video encoder 11 transmits the re-encoded SVC video to the display 13 through the communication network 12.

The communication network 12 provides a transmission path for transmitting the video from the video encoder 11 to the display 13, and a path for the display 13 to access the video encoder 11. In this case, examples of the communication network 12 include a mobile communication network such as wideband code division multiple access (W-CDMA), High-Speed Downlink Packet Access (HSDPA), third generation (3G), fourth generation (4G) and the like; a short distance communication network such as Bluetooth, Zigbee, Wi-Fi and the like; and a wired communication network such as the internet, public switched telephone network (PSTN) and the like.

The display 13 receives the generated SVC video from the video encoder 11, decodes the received SVC video, and displays the decoded SVC video.

In this case, the display 13 may be an Internet Protocol television (IPTV) or set top box and the like that is capable of receiving video data from the video encoder 11 and displaying the received video data, or a smart phone or a mobile communication terminal and the like with which a user may reproduce video data while moving, but without limitation.

The SVC method is a method for compressing a video sequence in various layers, that is, a base layer and an enhancement layer together. The base layer is a bit stream that may be decoded independently and that contains information for restoring an image of minimum quality. Non-scalable video encoding such as H.264 consists of only the base layer. The upper layer is a bit stream that may be added to improve the bit stream of the base layer. The upper layer cannot be decoded independently, but may be decoded when added to the base layer. Therefore, the SVC method is capable of encoding numerous video layers with one bit stream, each layer having a bit rate, frame rate, image size, and image quality. Consequently, according to the SVC, it is possible transmit one piece of encoded data, and restore an image suitable to each of the various performances of electronic apparatuses.

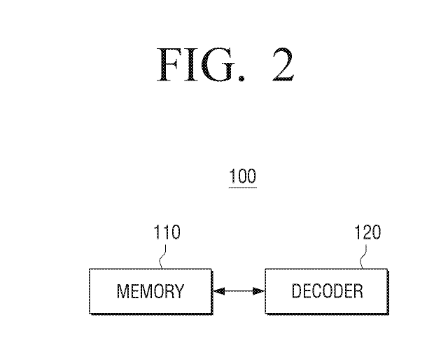

FIG. 2 is a block diagram illustrating a configuration of a decoding apparatus 100 according to an exemplary embodiment.

Hereinafter, an assumption is made that a bit stream is coded in a base layer and enhancement layer of the SVC method, but in another example, image information of a first definition and image information of a second definition may each be compressed in separate bit streams to be transmitted. Furthermore, it is to be assumed that a decoding process is made in block units containing a plurality of pixels. Herein, a block refers to a predetermined unit constituting a frame.

According to FIG. 2, the decoding apparatus 100 includes a memory 110 and decoder 120.

The memory 110 stores various kinds of data. The memory 110 may store an image frame of a first definition transmitted through a bit stream. Herein, the image frame of the first definition may be decoded by the decoder 120 that will be explained hereinafter, and then be stored in the memory 110. For example, the memory 110 may be a Random Access Memory (RAM), but without limitation.

The decoder 120 may decode an image frame of a second definition.

For this purpose, the decoder 120 may use an inter-prediction (that is, referring between screens) method of referring to another already decoded frame. However, the decoder 120 may use an intra-prediction method (that is, referring within screen) of referring to another block inside the subject frame to be decoded.

The inter-prediction method is a prediction method using the similarity between a current frame and another frame. In the inter-prediction method, from a reference image frame restored prior to the current frame, a reference area that is similar to the current area of the current area is extracted. Furthermore, the distance of coordinate between the current area and reference area is expressed in a motion vector, and the difference of pixel values between the current area and reference area is expressed in residual data. Therefore, by the inter-prediction for the current area, image information of the current area may be expressed in an index, motion vector, and residual data representing the reference image.

Furthermore, according to an exemplary embodiment, the inter-prediction may be performed in block units constituting a frame. The type of the block may be a square or rectangle that includes a plurality of pixels, or any geometric format. Furthermore, the block is not limited to a data unit of a size.

Furthermore, reference frames for the inter-prediction may be classified into short-term reference frames and long-term reference frames. The short-term reference frame may be a frame decoded just before the current frame or decoded recently according to a decoding order, whereas the long-term reference frame may be an image decoded long before the current frame but selected to be used as a reference frame for the inter-prediction and stored in the memory 110.

According to an exemplary embodiment, the decoder 120 may use an image frame of the first definition decoded in the bit stream compressed in the base layer of the SVC as the reference frame.

The decoder 120 may decode the image frame of the first definition using information such as the motion vector, residual data (difference of pixel values between the current area and reference area), size of the block being processed during decoding, and prediction mode (for example, intra made, inter mode, and skip mode) coded in the base layer. Herein, to utilize the decoded frame of the first definition as the reference frame to be used in decoding the image frame of the second definition, the decoder 120 may decode the frame of the first definition from the bit stream and store the decoded frame in the memory 110.

Furthermore, the decoder 120 obtains a motion vector regarding the block constituting the image frame of the second definition from the bit stream. The decoder 120 parses (a process of interpreting a source code into a machine code) the motion vector from the bit stream of the enhancement layer. Furthermore, the decoder 120 may perform dequantization and inversion for every block and restore residual data for each block. Herein, in the case in which only the motion difference value used to extract a motion vector is compressed in the bit stream, the decoder 120 may determine the motion vector of the current block using the difference of vector and motion near the current block. Herein, the current block refers to the block subjected to decoding of the current frame performed in block units.

Thereafter, the decoder 120 may correct the size of the motion vector and location of the block based on a predetermined scaling factor.

To decode the image frame of the second definition with reference to the image frame of the first definition, the decoder 120 corrects the size of the motion vector of the current vector and the location of the block so that they correspond to the definition of the reference frame. In the correcting process, the predetermined scaling factor is used. The predetermined scaling factor may be determined by a ratio of the first definition and second definition. For example, in the case in which the second definition is greater than the first definition, assuming that the first definition is 2 k and the second definition is 4 k, the scaling factor may be ½ or 2 that is the ratio of the first definition and the second definition.

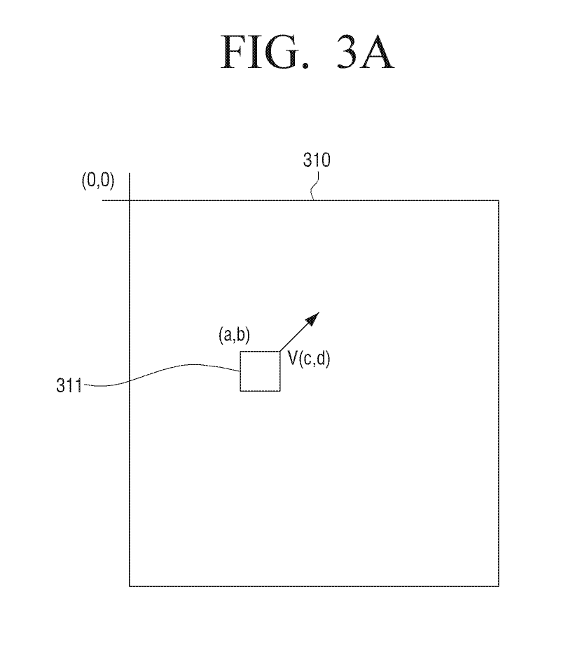

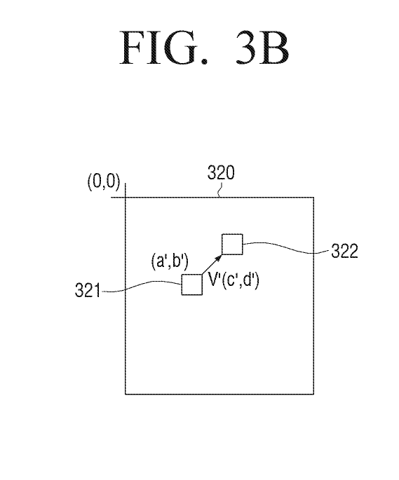

An example of correcting the size of the motion vector and the location of the block will be explained in detail with reference to FIGS. 3A and 3B.

FIGS. 3A and 3B are views illustrating a process of correcting a size of a motion vector and a location of a block, according to an exemplary embodiment.

Referring to FIGS. 3A and 3B, a current image frame 310 and a reference image frame 320 are shown. An assumption will be made that the current image frame 310 has a second definition of 4 k, and the reference image frame 320 has a first definition of 2 k. Furthermore, an assumption will be made that in the current image frame 310, the location of a current block 311 is coordinate (a,b) and the motion vector is V(c,d). Herein, the motion vector V(c,d) may be determined through motion prediction. The motion prediction is a prediction of the motion or displacement vector for placing the block matching the reference image frame 320 in the current block 311. Information for such a motion prediction is for example compressed in each layer of the scalable video coding and is provided to the decoding apparatus 100 in a bit stream.

To decode the current block 311, the decoder 120 refers to the reference image frame 320 of the first definition.

In this case, because the definitions of the image frames 310 and 320 are different from each other, the location (coordinate (a,b)) of the current block 311 and the motion vector (V(c,d)) are to be corrected to correspond to the first definition.

Accordingly, the decoder 120 may determine the location of the block corrected in the reference image frame 320 of the first definition by determining one coordinate of the pixels included in the block constituting the current image frame 310 of the second definition as the location of the block, and by correcting the determined coordinate based on the predetermined scaling factor.

Herein, the location of the block may be represented by a coordinate that may be determined having the pixel in the uppermost and leftmost of the pixels included in the block as the reference coordinate (0,0).

For example, because the current image frame 310 has the second definition of 4 k and the reference image frame 320 has the first definition of 2 k, the scaling factor is ½, and thus as in FIGS. 3A and 3B, the decoder 120 may determine the location of the block of the reference image frame 320 of the first definition corresponding to the current block 311 as (a′,b′)=(a/2,b/2), and determine the motion vector of the reference image frame 320 of the first definition corresponding to the motion vector V(c,d) of the current block 311 as V′(c′,d′)=v(c/2,d/2).

When the motion vector and location of the current block 311 are corrected as aforementioned, the decoder 120 may load from the memory 110 a block 322 represented by the motion vector V′(c′,d′) corrected based on a block 321 corrected in the reference image frame 320 of the first definition, and decode the current image frame 310 of the second definition based on the block 322 loaded from the memory 110.

In this case, the decoder 120 may scale the block 322 loaded from the memory 110 based on the predetermined scaling factor, and decode the current image frame 310 of the second definition based on the scaled block. Herein, the decoder 120 may perform an upscaling by performing an interpolation based on the pixel values of the pixels constituting the loaded block 322.

For example, assuming that the predetermined scaling factor determined by the ratio of the first definition and the second definition is 2, the decoder 120 scales the block 322 loaded from the memory 110 by applying a scaling factor 2. As a result, the width definition and the length definition of the loaded block 322 are each scaled by twice, that is, scaled to a block corresponding to the second definition.

Furthermore, the decoder 120 performs a motion compensation on the current block 311 using the block scaled to the second definition. Herein, the motion compensation is a process of actually aligning the block in the reference frame to the matching block in the current image frame 310.

As aforementioned, the decoder 120 may determine the reference block that the motion vector indicates in the reference image frame 320 of the first definition for every block of the current image frame 310 of the second definition, and compose residual data to the reference block to generate restored blocks, thereby finally restoring the current image frame 310 of the second definition.

The decoding apparatus 100 may further include a cache for storing the block of the reference image frame 320 of the first definition.

Accordingly, the decoder 120 may store the block 322 of the reference image frame 320 of the first definition in the cache, and load the block 322 of the reference image frame 320 of the first definition stored in the cache to decode the current image frame 310 of the second definition. For example, the decoder 120 may store frequently utilized blocks in the cache, load the blocks from the cache, and use the blocks in decoding. By doing this, it is possible to reduce waste of bandwidth for loading the block from the memory 110, and improve the decoding speed.

In the case of decoding the current image frame 310 of the second definition in block units using the reference image frame 320 of the first definition having a different definition, it is possible to correct the motion vector and location of the block of the current image frame 310 of the second definition to determine the reference block, scale the reference block in block units, and decode the current image frame 310 of the second definition through inter-prediction using the scaled reference block.

Accordingly, it is possible to minimize the amount of bandwidth and memory 110 consumed in storing and loading the reference image frame 320 in the process of scaling the entire reference image frame 320. As a result, it is possible to decode the bit stream input through the communication network 120 more quickly in real time and restore the image.

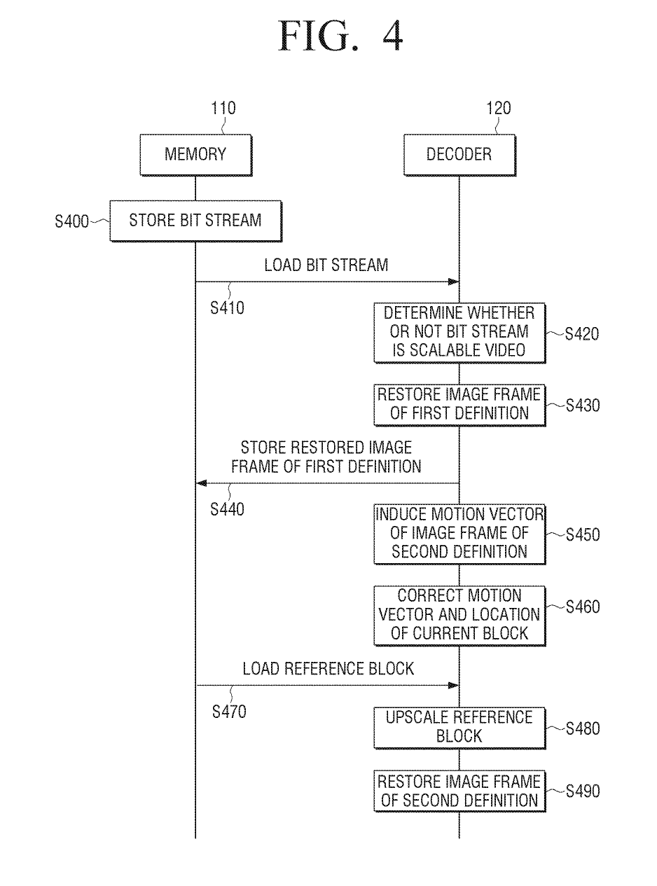

FIG. 4 is a flowchart illustrating a decoding process of the decoding apparatus 100, according to an exemplary embodiment.

In detail, FIG. 4 illustrates the decoding process in the case in which the video stream is compressed in the scalable video coding method. Herein, the decoder 120 may determine whether or not the video stream is a scalable video with reference to a codec header.

Referring to FIG. 4, the memory 110 stores the received bit stream (S400). The decoder 120 loads the bit stream from the memory 110 (S410). The decoder 120 determines whether or not the bit stream is a scalable video (S420), and in response to the bit stream being a scalable video, the decoder 120 restores the image frame of first definition (S430). Furthermore, the decoder 120 stores the restored image frame of the first definition in the memory 110 (S440).

The decoder 120 induces the motion vector of the image frame of the second definition that is intended to be restored (S450). The decoder 120 corrects the motion vector of the current block and the location of the current block of the image frame of the second definition (S460), and determines the reference block of the image frame of the first definition that is the reference frame. Thereafter, the decoder 120 loads the reference block from the memory 110 (S470), and upscales the reference block such that it corresponds to the image frame of the second definition (S480). Lastly, the decoder 120 composes residual data to the upscaled reference block to generate restored blocks (S490), thereby restoring the image frame of the second definition.

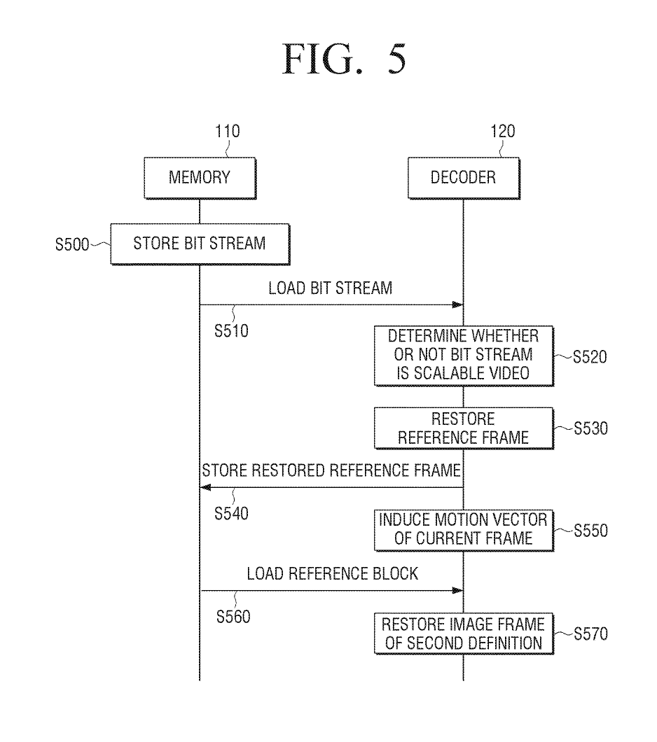

FIG. 5 is a flowchart illustrating a decoding process of the decoding apparatus 100, according to another exemplary embodiment.

In detail, FIG. 5 illustrates a case in which the video stream is not compressed in the scalable video coding method. It is a case of a decoding process in which the definition of the reference frame and the definition of the current frame (frame intended to be restored) are the same. In this case, the scaling factor may be 1.

Referring to FIG. 5, the memory 110 stores the received bit stream (S500). The decoder 120 loads the bit stream stored in the memory 110 (S510). The decoder 120 determines whether or not the bit stream is a scalable video (S520), and in response to the bit stream not being a scalable video, the decoder 120 restores the reference frame without a process of correcting the motion vector and location of the current block (S530). At the same time, the decoder 120 stores the restored reference frame in the memory 110 (S540).

The decoder 120 induces the motion vector of the current frame intended to be restored (S550). The decoder 120 determines the reference block of the reference frame based on the motion vector of the current frame, and loads the reference block from the memory 110 (S560). Herein, the process of upscaling the reference block is omitted. Lastly, the decoder 120 generates restored blocks by composing residual data to the reference block (S570), whereby the decoder 120 restores the current frame.

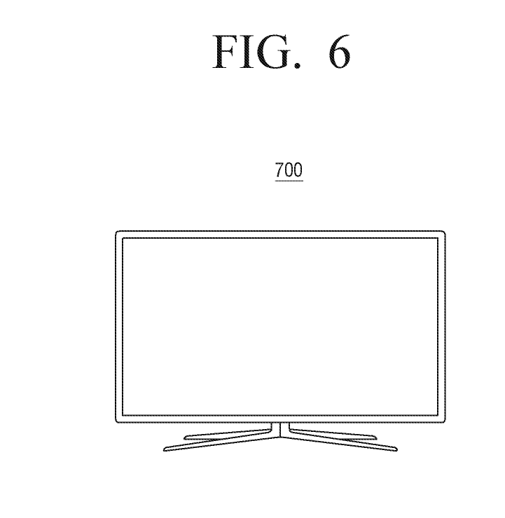

FIG. 6 is a view illustrating a display 700 according to an exemplary embodiment.

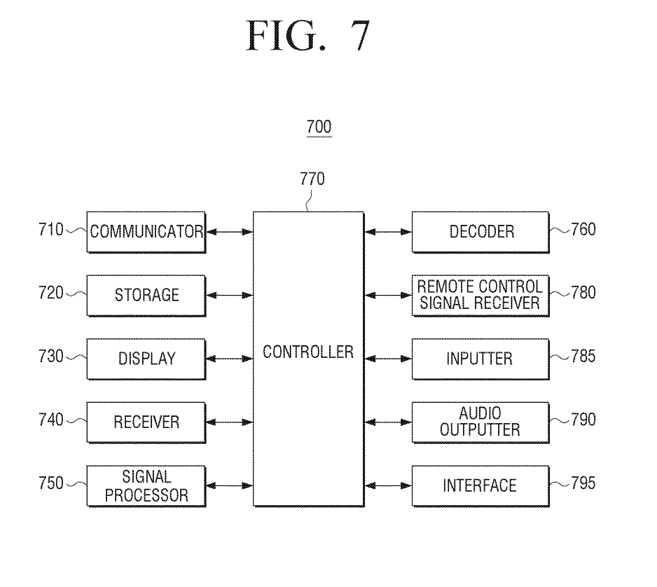

FIG. 6 illustrates a TV as an example of the display 700. The TV 700 includes the decoding apparatus 100. Therefore, when the image information encoded in the video encoder 11 is compressed in the video stream and received through the communication network 12, the TV 700 may control the decoding apparatus 100 to decode the bit stream, and display the decoded image. This will be explained in detail with reference to FIG. 7.

FIG. 7 is a block diagram illustrating a detailed configuration of the display 700 according to an exemplary embodiment.

Referring to FIG. 7, the display 700 includes a communicator 710, a storage 720, a display 730, a receiver 740, a signal processor 750, a decoder 760, a controller 770, a remote control signal receiver 780, an inputter 785, an audio outputter 790, and an interface 795.

The communicator 710 performs communication via the network (communication network). The communicator 710 may perform communication with various external devices (for example, other device or server) connected to the network, using the network address allocated to the display 700 for network communication.

Herein, the network address may be an Internet Protocol (IP) address. That is, the communicator 710 may perform communication with another external device connected to the internet using the IP address.

The communicator 710 may perform network communication using various communication methods.

The communicator 710 may perform network communication using various communication methods such as the wired/wireless Local Area Network (LAN), Wi-Fi, Wide Area Network (WAN), Ethernet, Bluetooth, Zigbee, Universal Serial Bus (USB), Institute of Electrical and Electronics Engineers (IEEE) 1394 and the like. For this purpose, the communicator 710 may be equipped with various communication interfaces for performing network communication according to various communication methods. For example, in the case of performing communication in the wired LAN method, the communicator 710 may be equipped with a wired LAN card, and in the case of performing communication in the Wi-Fi method, the communicator 710 may be equipped with a Wi-Fi communication chip.

The storage 720 stores various data and operating systems (OS) for driving and controlling the display 700.

Furthermore, the storage 720 stores basic programs that are executable in the display 700. Herein, the basic programs may be application programs for providing the basic functions (or basic services) of the display 700.

The basic programs are application programs that are initially installed in the display 700 by the manufacturer at the time of manufacturing the display 700. They are application programs that cannot be removed arbitrarily by the user of the display 700.

For example, in the case in which the manufacturer of the display 700 intends to provide a contents search function, contents replay function, function of searching various application programs installed in the display 700, internet access function and setup function as basic functions, the storage 720 may store basic programs that provide the basic functions.

Furthermore, the storage 720 may store a downloadable program that is executable in the display 700. Herein, the downloadable program may be an application program that the display 700 uses to provide additional functions (or additional services) besides the basic functions.

The downloadable program is an application program that the user may arbitrarily install in the display 700 or remove from the display, unlike the basic programs.

For example, the user may download a download program for providing additional functions such as a game function and chatting function and the like from an external device and install the download program in the display 700, and the storage 720 may store the download program for providing the additional functions.

For this purpose, the storage 720 may be realized as a storage medium such as a nonvolatile memory (for example, flash memory), Electrically Erasable ROM (EEROM), hard disc and the like.

The storage 720 may store the basic program and download program in separate areas. The storage 720 may divide a storage area inside the storage medium into a plurality of storage areas, and store the basic program and download program in different storage areas. For example, in the case in which the storage 720 is realized as a flash memory, the storage 720 may store the basic program in a first storage area of the flash memory, and store the download program in a second storage area of the flash memory. In this case, the storage area for storing basic programs may be a storage area not arbitrarily approachable by the user, but the storage area for storing download programs may be a storage area approachable by the user. That is, the user cannot arbitrarily remove the basic program stored in the storage area for storing basic programs, but the user may remove the download program stored in the storage area for storing download programs.

In the storage area for storing basic programs, various data and operating systems for driving and controlling the display 700 may be stored together, and these various data and operating systems may be referred to as firmware.

However, this is an example, and thus the storage 720 may store the basic program and download program in different storage media. That is, in the case in which the storage 720 is realized as a plurality of flash memories, the basic program may be stored in a first flash memory, and the download program may be stored in a second flash memory, for example.

The storage 720 may store the bit stream received from the communicator 710 sequentially. Furthermore, in the case in which there is a request from the decoder 760 that will be explained hereinafter, the storage 720 may provide the stored bit stream. Furthermore, the storage 720 may receive and store the reference frame restored from the decoder 760, and provide the stored reference frame to the decoder 760 in block units.

The display 730 displays various screens. The display 730 may display a menu for executing the basic program. Herein, the menu may include a menu item for executing the basic program that may provide the basic functions of the display 700.

For this purpose, the display 730 may be realized as an Liquid Crystal Display (LCD), Organic Light Emitting Display (OLED), or Plasma Display Panel (PDP) and the like.

The receiver 740 may receive broadcast contents (or broadcast signals). The broadcast contents may include an image, audio and additional contents (for example, Electronic Program Guide (EPG)), and the receiver 740 may receive the broadcast contents from various sources such as a groundwave broadcast, cable broadcast, satellite broadcast, internet broadcast and the like. For example, the receiver 740 may receive a video stream in which a broadcast content image is coded.

Herein, the receiver 740 may be realized in a format that includes a configuration such as a tuner, demodulator, equalizer and the like to receive the broadcast contents being transmitted from a broadcasting station.

The signal processor 750 performs signal processing of the contents received through the receiver 740. The signal processor 750 may perform operations such as decoding, scaling, frame rate conversion and the like on the images constituting the contents into a format outputtable from the display 730. Furthermore, the signal processor 750 may perform the signal processing such as decoding and the like on the audio constituting the contents into a format outputtable from the audio outputter 790.

The decoder 760 restores an original image through a process of decoding the current frame from the bit stream of the image received from the receiver 740.

For example, in the case in which the bit stream is generated in the scalable video coding method, the decoder 760 restores the reference frame using the motion vector of the base layer. Furthermore, the decoder 760 corrects the motion vector of the enhancement layer to be suitable to the definition of the base layer, to determine the reference block of the reference frame. Thereafter, the decoder 760 restores the current frame using the reference block.

Herein, the decoder 760 may further include a memory. The decoder 760 may store the reference frame in the memory, load the block of the reference frame currently being processed, and use the loaded block in decoding the current frame.

Furthermore, the decoder 760 may be realized as one chip, or as an apparatus connected to the display 700 so that it may operate outside the display 700. Herein, the decoder 760 may be realized in various formats besides the aforementioned format.

Herein, in the case in which the storage 720 includes a RAM, the decoder 760 may perform a decoding process using the storage 720. Therefore, the decoder 760 may not be equipped with a separate memory.

The controller 770 controls the overall operations of the display 700. The controller 770 may include a Central Processing Unit (CPU), Read Only Memory (ROM), and RAM for operation of the display 700.

In the ROM, a set of commands for system booting is stored. When a turn on command is input and power is supplied, the CPU copies an operating system (O/S) stored in the storage 720 to the RAM according to the command stored in the ROM, and executes the O/S to boot the system. When the booting is completed, the main CPU copies various application programs stored in the storage 720 to the RAM, and executes the application program copied to the RAM to perform various operations.

The CPU accesses the storage 720, and performs booting using the O/S stored in the storage 720. Furthermore, the CPU performs various operations using various programs, contents, data and the like stored in the storage 720.

The remote control signal receiver 780 receives a remote control signal being input from a remote control.

For example, the remote control signal receiver 780 may receive a remote control signal for turning on the power of the display 700 or for displaying a menu. When a remote control signal for turning on the power of the display 700 or a remote control signal for displaying the menu is received, the controller 770 may display a menu for executing a basic program. Herein, the controller 770 may configure the menu differently according to the location of the display 700 and display the menu.

The remote control signal receiver 780 may receive various remote control signals besides the aforementioned. For example, the remote control signal receiver 780 may receive a remote control signal for changing the channel, adjusting the volume and the like, and the controller 770 may change the channel of the display 700 or adjust the volume according to the received remote control signal.

The inputter 785 receives various user commands. The controller 770 may execute a function corresponding to the user command input into the inputter 785.

For example, when the user command for turning on the power of the display 700 or the user command for displaying the menu is input through the inputter 785, the controller 770 may display the menu for executing the basic program. In this case, the controller 770 may configure the menu differently according to the location of the display 700 and display the menu.

Besides the aforementioned, the inputter 785 may receive an input of a user command for changing the channel, adjusting the volume and the like, and the controller 770 may change the channel or adjust the volume according to the input user command.

The audio outputter 790 may convert the audio signal being output from the signal processor 750 into sound and output the sound through a speaker, or output the sound to an external device connected via an external output terminal.

The interface 795 connects various other devices and the display 700. Furthermore, the interface 795 may transmit the contents and the like pre-stored in the display 700 to other devices, or receive the contents and the like from the other devices.

For this purpose, the interface 795 may include at least one among a High-Definition Multimedia Interface (HDMI) input terminal, component input terminal, PC input terminal, and USB input terminal.

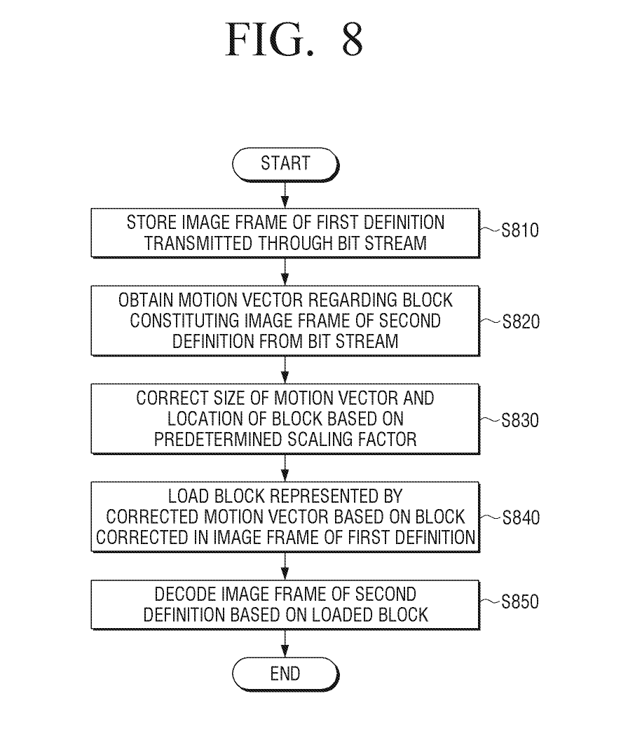

FIG. 8 is a flowchart illustrating a decoding method of the decoding apparatus 100, according to another exemplary embodiment 100.

First of all, the decoding method stores an image frame of a first definition transmitted through a bit stream (S810), and obtains a motion vector regarding a block constituting an image frame of a second definition from the bit stream (S820). The decoding method further corrects a size of the motion vector and a location of the block based on a predetermined scaling factor (S830), and loads a block represented by the corrected motion vector based on a pre-corrected block in the image frame of the first definition (S840). The decoding method further decodes the image frame of the second definition based on the loaded block (S850).

Herein, the second definition is greater than the first definition, and the predetermined scaling factor may be determined by the ratio of the first definition and the second definition.

In this case, the decoding method may further include determining one coordinate of the pixels included in the block constituting the image frame of the second definition as the location of the block, and determining the location of the corrected block in the image frame of the first definition by correcting the determined coordinate based on the predetermined scaling factor to.

Furthermore, the decoding method may further include scaling the loaded block based on the predetermined scaling factor, and decoding the image frame of the second definition based on the scaled block.

Furthermore, the decoding method may further include storing the block of the image frame of the first definition in a cache, loading the block of the image frame of the first definition stored in the cache, and decoding the image frame of the second definition.

In this case, the bit stream may be coded in the base layer and enhancement layer of the scalable video coding method.

In addition, the exemplary embodiments may also be implemented through computer-readable code and/or instructions on a medium, e.g., a computer-readable medium, to control at least one processing element to implement any above-described exemplary embodiments. The medium may correspond to any medium or media that may serve as a storage and/or perform transmission of the computer-readable code.

The computer-readable code may be recorded and/or transferred on a medium in a variety of ways, and examples of the medium include recording media, such as magnetic storage media (e.g., ROM, floppy disks, hard disks, etc.) and optical recording media (e.g., compact disc read only memories (CD-ROMs) or digital versatile discs (DVDs)), and transmission media such as Internet transmission media. Thus, the medium may have a structure suitable for storing or carrying a signal or information, such as a device carrying a bitstream according to one or more exemplary embodiments. The medium may also be on a distributed network, so that the computer-readable code is stored and/or transferred on the medium and executed in a distributed fashion. Furthermore, the processing element may include a processor or a computer processor, and the processing element may be distributed and/or included in a single device.

The foregoing exemplary embodiments are examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A decoding apparatus comprising:
a memory configured to store a reference image frame of a first definition that is decoded from a bit stream; and
a decoder configured to:
determine, from the bit stream, a motion vector of a current block of a current image frame of a second definition;
correct a size of the motion vector and a location of the current block based on a scaling factor;
load, from the memory, a reference block that is the corrected motion vector away from the corrected location of the current block in the reference image frame; and
decode the current image frame based on the reference block.

2. The decoding apparatus according to claim 1, wherein the second definition is greater than the first definition, and
the scaling factor is a ratio of the first definition and the second definition.

3. The decoding apparatus according to claim 1, wherein the decoder is further configured to:
determine coordinates of pixels of the current block as the location of the current block; and
correct the coordinates based on the scaling factor to correct the location of the current block.

4. The decoding apparatus according to claim 1, wherein the decoder is further configured to:
scale the reference block based on the scaling factor; and
decode the current image frame based on the scaled reference block.

5. The decoding apparatus according to claim 1, further comprising a cache configured to store the reference block,
wherein the decoder is further configured to:
store the reference block in the cache; and
load the reference block from the cache.

6. The decoding apparatus according to claim 1, wherein the bit stream is coded in a base layer and an enhancement layer of a scalable video coding method.

7. A decoding method comprising:
storing a reference image frame of a first definition that is decoded from a bit stream;
determining, from the bit stream, a motion vector of a current block of a current image frame of a second definition;
correcting a size of the motion vector and a location of the current block based on a scaling factor;
loading a reference block that is the corrected motion vector away from the corrected location of the current block in the reference image frame; and
decoding the current image frame based on the reference block.

8. The method according to claim 7, wherein the second definition is greater than the first definition, and
the scaling factor is a ratio of the first definition and the second definition.

9. The method according to claim 7, further comprising determining coordinates of pixels of the current block as the location of the current block,
wherein the correcting the location of the current block comprises correcting the coordinates based on the scaling factor.

10. The method according to claim 7, further comprising scaling the reference block based on the scaling factor,
wherein the decoding comprises decoding the current image frame based on the scaled reference block.

11. The method according to claim 7, further comprising:
storing the reference block in a cache; and
loading the reference block from the cache.

12. The method according to claim 7, wherein the bit stream is coded in a base layer and an enhancement layer of a scalable video coding method.
